(19) United States
(12) Patent Application Publication
(10) Pub. No.: US 2003/0002385 A1
(43) Pub. Date: Jan. 2, 2003

(54) Convertible drink shaker and glass

(76) Inventors: Richard M. Pola, Hermosa Beach, CA (US); Lisa L. Pola, Hermosa Beach, CA (US)

Correspondence Address: Crockett & Crockett, Suite 400, 24012 Calle De La Plata, Laguna Hills, CA, 92653, US

(21) Appl. No.: 09/897,754

(22) Filed: Jun. 29, 2001

(51) Int. Cl. A47J 43/27

(52) U.S. Cl. 366/130; 220/568

(57) ABSTRACT

A drink shaker and drinking glass are combined into one device. The device can be formed by three elements, a shaker cup, a shaker lid, and a strainer, which are convertible from a drink shaker to a drinking glass. Further, the strainer can also be used as a coaster for the drinking glass.

### FIELD OF THE INVENTIONS

The invention relates generally to drink shakers and drinking glasses.

### BACKGROUND OF THE INVENTIONS

Drink shakers are a generally used for shaking martinis and margaritas. They generally include a shaker cup and a shaker lid, and perhaps a strainer as well. In use, the shaker cup is filled with the ingredients for the particular drink. Depending upon the drink, ice is sometimes added. The shaker lid is placed on top of the shaker cup and the drink shaker is then shaken. The contents are then poured out of the shaker into a drinking glass and served.

Drinking glasses come in many shapes and sizes. The type of drink being served generally determines the shape and size of the glass. There are, for example, martini glasses, margarita glasses, wine glasses, ice tea glasses etc., each of them having a distinctive shape. These terms denote quite specific and well known shapes of glasses.

Drink shakers and drinking glasses are complete in and of themselves and are, generally, used in conjunction with one another. In use the drink ingredients are poured into the drink shakers, which are then shaken to mix the ingredients of the drink together. Then, the finished drink is poured from the drink shaker into a drinking glass.

Many bars and restaurants make an effort to differentiate their services and products from those of their competitors. Currently, fruit and mini-umbrellas are used to decorate the glasses, and distinctively colored liquors are also being used. Some bars give away souvenir glasses and such. Other bars are serving their drinks in a drink shaker and giving the customer a glass to pour the drink into the glass themselves. New ways of serving and presenting drinks to please and entertain customers are always being sought as a means for distinguishing a bar or restaurant from its competition.

### SUMMARY

A new device for serving drinks is described. A drink shaker and drinking glass are all combined into one device—a convertible drink shaker and glass. The device generally includes three separate pieces, a shaker cup, a shaker lid and a strainer. The strainer can also be used as a coaster when placed under the drinking glass.

### BRIEF DESCRIPTION OF THE DRAWINGS

FIG. 1 is a side view of the device.

FIG. 2 is an exploded view from the side of the device.

FIG. 3 is an exploded view from the side of the drinking glass.

### DETAILED DESCRIPTION OF THE INVENTIONS

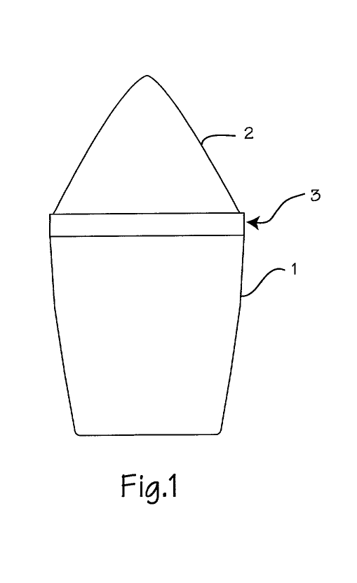

FIG. 1 illustrates the arrangement of two elements of the device, which include the shaker cup 1 and the shaker lid 2. The shaker lid and the shaker cup each having an open end and a closed end. The open end of the shaker cup and the open end of the shaker lid are sized and dimensioned relative to each to permit releasable attachment of the shaker lid to the shaker cup. Further, the closed end of the shaker lid is sized and dimensioned to fit into the open end of the shaker cup. Additionally the shaker lid has a depth suitable for use as a drinking cup.

The shaker lid is removably mounted on top of the shaker cup forming a joint 3. The joint is a male-female joint. The joint is tight to the degree necessary to permit a fairly secure releasable or removable press-fit, pressure fit, or threaded connection which may be broken with the application of moderate force, without the assistance of tools. The elements can be composed of plastic, metal, glass, or other suitable material, and may be formed by injection molding, machining or extrusion.

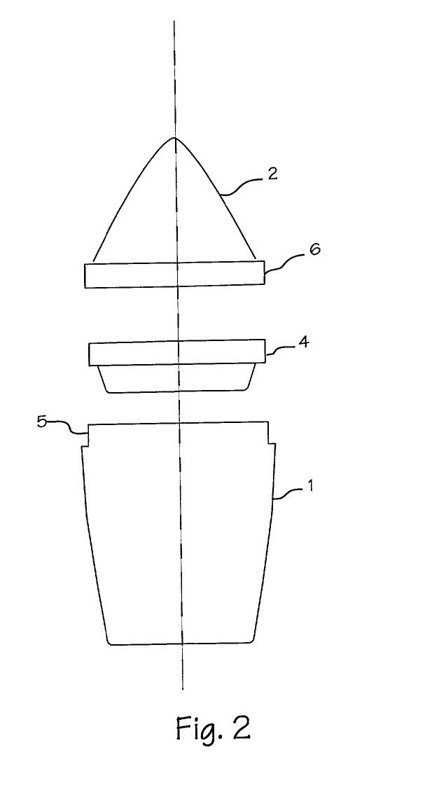

FIG. 2 shows the three basic elements of the device. The three basic elements are the shaker cup 1, the shaker lid 2 and the strainer 4. The joint includes a lip 5 that is located at the open end of the shaker cup 1 and a rim 6 that is located at the open end of the shaker lid 2. The lip of the shaker cup forms the male portion and the rim forms the female portion. As the lip mates with the rim, the joint is formed. The joint forms a seal that holds the drink ingredients in the shaker as it is being shaken.

The strainer is a manually removable strainer that fits inside of the lip of the shaker cup. The device may be manufactured such that the strainer fits over the lip and the rim fits over the strainer to form the joint, or the strainer is placed on the lip after the shaker lid is removed in order to pour the drink ingredients out of the shaker cup while holding in the ice.

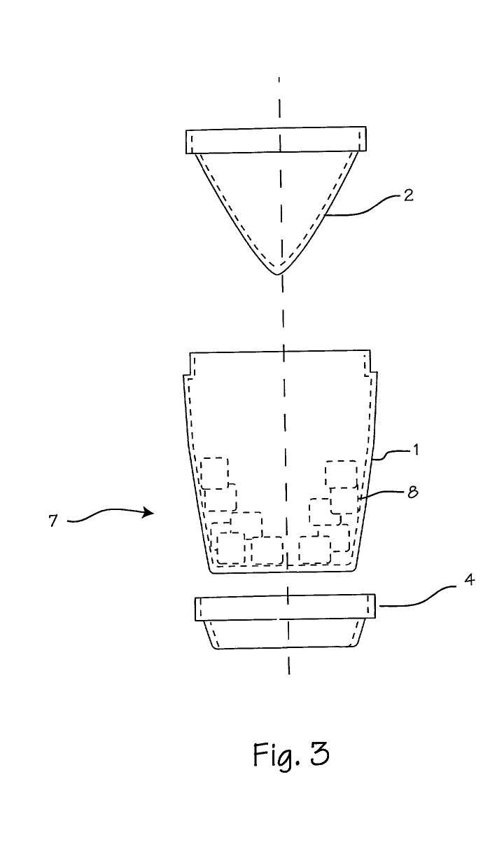

FIG. 3 illustrates the elements of the drinking glass in an exploded arrangement. The drinking glass 7 is formed by the inverted shaker lid which sets down into the open end of the shaker cup and the shaker cup fits down into the strainer 4 such that the strainer acts as a coaster. The glass bowl 2, which is the inverted shaker lid 2, is shaped like the bowl of a martini glass. A martini glass is generally discernable by its broad-based inverted conical glass bowl supported by a glass stem. The glass bowl 2 is placed into the shaker cup 1 for support. Because the shaker cup contains ice 8, the contents of the glass bowl are cooled by the ice. The ice, however, is not in contact with the drink ingredients and therefore, as the ice melts, it does not dilute the drink.

In using the device, the shaker cup is filled with the drink ingredients and ice, then the strainer is placed inside of the shaker cup and the shaker lid is placed on top of the strainer to form the joint which seals the drink ingredients and ice inside the shaker. The device is served as shown in FIG. 1, with the shaker lid mounted on top of the shaker cup and the strainer placed inside the shaker cup. Once the drink has been shaken, the customer removes the shaker lid off of the shaker cup and inverts the shaker lid to form the glass bowl. The strainer is in place inside the shaker cup and the customer just pours the contents of the strainer cup into the glass bowl.

Alternatively, once the drink has been shaken the customer then lifts the shaker lid off of the shaker cup and places the strainer onto the lip of the shaker cup. Then the shaker lid is inverted and held in the customer's hand. The contents of the shaker cup are then poured into the glass bowl.

The strainer is then removed from the lip of the shaker cup. Once the strainer is removed from inside the lip the glass bowl can be placed into the shaker cup, thus the glass bowl is supported by the shaker cup. Also the strainer can be placed onto the bar and used as a coaster by placing the closed end of the shaker cup down into the strainer.

In drinking from the glass, the glass bowl is lifted out of the ice bath by the customer and a drink is taken and the glass bowl is returned to the shaker cup for support and the ice bath, which keeps the drink ingredients cool. Alternatively, the glass bowl and the shaker cup can be lifted up together by the customer and a drink is taken.

Thus, while the preferred embodiments of the device have been described in reference to the environment in which they were developed, they are merely illustrative of the principles of the inventions. Other embodiments and configurations may be devised without departing from the spirit of the inventions and the scope of the appended claims.

We claim:

1. A convertible drink shaker and glass comprising:
a shaker cup having an open end and a closed end; and
a shaker lid having an open end and a closed end, the open end of the shaker lid being removably mounted to the open end of the shaker cup;
wherein the open end of the shaker cup and the open end of the shaker lid are sized and dimensioned relative to each to permit releasable attachment of the shaker lid to the shaker cup; and
wherein the closed end of the shaker lid is sized and dimensioned to fit into the open end of the shaker cup and the shaker lid has a depth suitable for use as a drinking bowl.

2. A convertible martini shaker and glass comprising:
a shaker cup having an open end and a closed end; and
a shaker lid removably mounted to the open end of the shaker cup, the shaker lid being shaped like a martini glass bowl;
wherein the shaker lid when inverted is a glass bowl, and the shaker cup and the glass bowl are sized and dimensioned relative to each other to permit releasable attachment of the shaker cup and the glass bowl, and the shaker cup supports the glass bowl.

3. A convertible drink shaker and glass comprising:
a shaker cup having a lip, an open end, and a closed end;
a shaker lid removably mounted to the open end of the shaker cup, the shaker lid having a open end and a closed end; and
a strainer removably fitted inside the lip of the shaker cup;
wherein the strainer is sized and dimensioned to fit inside the lip of the shaker cup and permit releasable attachment of the strainer;
wherein the closed end of the shaker lid is sized and dimensioned to fit into the open end of the shaker cup and the shaker lid has a depth suitable for use as a drinking bowl; and
wherein the closed end of the shaker lid is sized and dimensioned to fit into the open end of the shaker cup.
cup supports the glass bowl.
